(19) United States
(12) Patent Application Publication
(10) Pub. No.: US 2004/0171492 A1
(43) Pub. Date: Sep. 2, 2004

(54) Method for improving the resistance of plant protection agents to rain

(76) Inventors: Hans-Georg Mainx, Leichlingen (DE); Horst-Werner Wollenweber, Hamburg (DE); Claudia Gruenewald, Duesseldorf (DE)

Correspondence Address: COGNIS CORPORATION, PATENT DEPARTMENT, 300 BROOKSIDE AVENUE, AMBLER, PA, 19002, US

(21) Appl. No.: 10/481,138

(22) PCT Filed: Jun. 25, 2002
(86) PCT No.: PCT/EP02/06984

(30) Foreign Application Priority Data
Jul. 4, 2001 (DE) 101 32 459.6

(51) Int. Cl. A01N 25/00

(52) U.S. Cl. 504/358

(57) ABSTRACT

A process for decreasing the amount of an agricultural chemical composition deposited on the surface of a plant that is removed by exposure to rain comprising adding to the agricultural chemical composition from 0.5% to 5% by weight of a compound of formula (I):

RO—(C₂H₄O)ₙ(C₃H₆O)ₘ—R′ (I)

wherein RO is an alcohol residue selected from the group consisting of a branched or linear, saturated or unsaturated monohydric alcohol having 1 to 6 carbon atoms or a polyol having from 2 to 12 carbon atoms and from 2 to 6 hydroxyl groups; R′ is hydrogen or —CO—R″, wherein R″ is a branched or linear, saturated or unsaturated alkyl group having from 5 to 29 carbon atoms; n is a number from 1 to 50 and m is 0 or a number from 1 to 20.

This invention relates to the improvement of the resistance of plant protection agents to rain by addition of certain alkoxylated compounds.

With the current trend of making plant protection agents selective, effective and environmentally compatible, the significance assumed by the rain resistance of formulations is also steadily increasing. This applies to all formulations, but especially to nonsystemic active substances which do not penetrate into the plant, such as contact insecticides and contact fungicides, and to water-soluble active substances of which the residence time on the leaf is also critical to their effect. In addition, the quantity of active substance applied can be significantly reduced by using suitable substances which prevent the plant protection agent from being washed off by rain after application.

The problem addressed by the present invention was to improve the resistance of agrochemical formulations to rain. It has been found that the use of certain alkoxylated compounds as adjuvants increases resistance to rain.

The present invention relates to the use of compounds corresponding to general formula (I):

RO—(C₂H₄O)ₙ(C₃H₆O)ₘ—R′ (I)

in which

RO is an alcohol residue selected from the group of branched or linear, saturated or unsaturated monohydric alcohols containing 1 to 6 carbon atoms or polyols containing 2 to 12 carbon atoms and 2 to 6 hydroxyl groups,

R′ is hydrogen and/or a group —CO—R″, where R″ is a branched or linear, saturated or unsaturated alkyl group containing 5 to 29 carbon atoms,

n is a number of 1 to 50 and

m is 0 or a number of 1 to 20,

for improving the rain resistance of agrochemical formulations after their application to the surfaces of plants.

Agrochemical formulations in the context of the present invention are broadly understood to be any compounds which contain active substances from the group of fertilizers, pesticides, plant fortifying agents or other active substances for use in horticulture. The use of the compounds according to the invention for pesticide-containing formulations is particularly preferred because particularly efficient application is required in their case on account of the expensive and—in some instances—ecologically critical ingredients.

The alkoxylated compounds corresponding to formula (I) are known per se and are described, for example, in U.S. Pat. No. 2,678,935 of which the disclosure is also part of the present application.

The compounds corresponding to formula (I) may be prepared by any of the methods known to the expert, for example by esterification of fatty acids with alkoxylated methanol, as described in U.S. Pat. No. 3,539,518. However, this process is attended by certain disadvantages. It involves two stages, the esterification step is very time-consuming and the products are colored by the high reaction temperatures. In addition, fatty acid methyl ester ethoxylates produced by this process have relatively high OH values after the esterification step which can be problematic for some applications. Another method comprises directly reacting fatty acid esters with alkylene oxides in the presence of transition metal catalysts, as described in U.S. Pat. No. 4,022,808. However, the fatty acid alkyl ester alkoxylates are preferably produced by the heterogeneously catalyzed direct alkoxylation of fatty acid alkyl esters with ethylene oxide and/or propylene oxide on calcined or hydrophobicized hydrotalcites. These synthesis processes are described in detail in WO 90/13533 and WO 91/15441 of which the disclosure is also part of the present application. The products formed are distinguished by a low OH value, the reaction is carried out in a single stage and light-colored products are obtained. The fatty acid alkyl esters used as starting materials may be obtained from natural oils and fats or may be synthesized.

The alkoxylated fatty acid esters contain at least 1 mol ethylene oxide groups per mol ester. Compounds of formula (I) which contain between 1 and 50 mol and preferably between 1 and 30 mol ethylene oxide are preferred. In addition to the ethylene oxide units, between 1 and 10 propylene oxide groups are preferably present in the molecule. Compounds of formula (I) which contain between 1 and 30 mol ethylene oxide per mol ester and 1 to 10 mol propylene oxide groups are also preferred. These mixed ethylene oxide/propylene oxide adducts may be both compounds which have been reacted with a mixture of ethylene and propylene oxide and compounds which have been reacted with ethylene and propylene oxide in two separate steps. The alkoxides are statistically distributed among the OH groups present in dependence upon the production process.

Where compounds of formula (I) containing polyols as the alcohol residue RO are used, the numbers relating to the quantity of ethylene or propylene oxide units (indices n and m) are always based on the molecule as a whole. However, it is known that the exact distribution of ethylene or propylene oxide units among the various hydroxyl groups of the polyols obeys a statistical distribution dependent upon the synthesis process.

The fatty acid ester groups ═CO—R″ contain alkyl groups R″ with 5 to 29 carbon atoms. Suitable fatty acid components are natural or synthetic fatty acids, more particularly linear, saturated or unsaturated C₆₋₃₀ fatty acids, including the technical mixtures thereof obtainable by lipolysis from animal and vegetable fats and oils, for example from coconut oil, palm kernel oil, soybean oil, sunflower oil, rape or rapeseed oil, cottonseed oil, fish oil, bovine tallow and lard; special examples are caprylic, capric, lauric, lauroleic, myristic, myristoleic, palmitic, palmitoleic, oleic, linoleic, linolenic, elaidic, arachic, gadoleic, behenic and erucic acid.

The alcohol component RO may be selected from linear or branched, saturated or unsaturated monohydric alcohols containing 1 to 6 carbon atoms, for example methanol, ethanol, n- and i-propanol, n- and i-butanol, pentanol, hexanol, 2-ethylhexanol and cyclohexanol. Suitable polyols containing 2 to 6 carbon atoms are, for example, ethylene glycol, 1,2-propylene glycol, 1,2-butylene glycol, glycerol or trimethylol propane and pentaerythritol.

Basically, all the hydroxyl groups of the alcohols are substituted by the alkoxides, but not all the terminal alkoxide groups are capped by ester groups. Accordingly, where polyols, such as glycerol or ethylene glycol, are used as the alcohol component RO, the preparations may contain compounds of formula (I) obtained by reaction both of the full esters and of the partial esters with alkoxides. However, preferred compounds of formula (I) are those in which all the hydroxyl groups of the alcohols are alkoxylated and all the terminal alkoxide groups are capped by ester groups with the formula —CO—R″. Accordingly, in these preferred compounds, R″ in formula (I) exclusively represents a branched or linear, saturated or unsaturated alkyl group containing 5 to 29 carbon atoms.

Another preferred embodiment of the invention is characterized by the use of alkoxylated fatty acid esters of formula (I) of which the fatty acid component is selected from linear, unbranched C₆₋₁₈ fatty acids and of which the alcohol component is methanol, these esters of formula (I) preferably containing between 1 and 3 mol propylene oxide and between 1 and 6 mol ethylene oxide per mol ester. Such compounds may be obtained, for example, by the above-described reactions of palmitic, stearic, oleic, linolic or linolenic acid, lauric and myristic acid or esters thereof with alkoxides. Besides the saturated acids, unsaturated acids may also be successfully used for the purposes of the teaching of the invention.

So far as choice of the fatty acid component is concerned, it is of advantage to select unsaturated, preferably polyunsaturated, compounds. Thus, unsaturated carboxylic acids with iodine values (I.V.) of 100 to 170 are particularly preferred. The preferred natural raw material base for these fatty acids is soybean oil, sunflower oil, rapeseed oil, cottonseed oil or fish oil.

Also suitable are alkoxylated compounds where the alcohol component is glycerol and the fatty acid component is selected from saturated or unsaturated, branched or unbranched fatty acids containing 18 to 22 carbon atoms and the esters contain between 1 and 3 mol ethylene oxide per mol ester. Compounds of formula (I) in which n has a value of 5, 10, 30 or 50 and m is 0 are particularly preferred. Such compounds may be obtained, for example, by reaction of glycerol esters of natural fatty acids such as, for example, palm oil, rapeseed oil, soybean oil, linseed oil, poppyseed oil or castor oil with ethylene oxide. Castor oil, soybean oil, linseed oil and rapeseed oil ethoxylates are preferably used, rapeseed oil, soybean oil and/or linseed oil ethoxylates, preferably containing 5 to 50 mol ethylene oxide per mol oil, being particularly preferred. Of these rapeseed oil, soybean oil or linseed oil ethoxylates, derivatives containing 5 to 40, preferably 5 to 20 and more particularly 5 to 10 mol ethylene oxide are preferably used.

Besides the above-mentioned vegetable oils as the raw material base for the alkoxylates used in accordance with the invention, it has proved to be of advantage to use products based on fish oil. Of these fish oil alkoxylates, derivatives which are only ethoxylated, preferably with 5 to 40, more preferably with 5 to 20 and most preferably with 5 to 10 mol ethylene oxide, are preferably used.

In addition, the compounds of formula (I) may additionally contain propylene oxide units, in which case they may contain 1 to 5 mol propylene oxide in the molecule.

Rapeseed oil itself is obtained from the seeds of rape or turnips. Rape seed contains ca. 40-50% oil and ca. 30% protein. It has a melting point of 0 to 2° C. Old rape varieties contain high levels (35-64%) of erucic acid, 5-10% gondo adi [(Z)-11-eicosenoic acid, C₂₀H₃₈O₂, molecular weight 310.52, melting point 24-25° C.] and nervonic acid besides 13-38% oleic acid, 10-22% linolic acid and 2-10% linolenic acid. New rape varieties usually contain <2% of the long-chain monoene fatty acids. Recently, the cultivation of new varieties has led to so-called double-zero varieties which only contain traces of erucic acid but are rich in oleic acid (50-65%), linolic acid (15-30%) and linolenic acid (5-13%).

Linseed oil is a golden-yellow (pale yellowish when bleached), fatty drying oil which is obtained in a yield of 20-30% from the crushed seeds of flax without heat at pressures of 180-350 bar using multidaylight presses. The press residue (press cake, oil cake) still contains 7-8% oil. The mucilaginous substances adhering to the crude oil are removed by heating to 280° C. or by filtration with bleaching earth. Linseed oil is a complex mixture of glycerol esters of predominantly unsaturated fatty acids. Of all fats and oils, linseed oil has the highest iodine value.

Soybean oil is a yellowish to brown-yellow, fatty, semidrying oil which is obtained from soybeans or rough-ground soybeans by pressing and/or extraction with hydrocarbons (for example hexane). Oil content of the soybeans: 17-22%. 55-65% of the total fatty acids of soybean oil are polyunsaturated fatty acids. The sterol content of soybean oil is on average 0.37% (of which 0.3-0.5% is chlolesterol). The sterol content can be reduced by ca. 30% by refining. In addition, soybean oil contains free fatty acids, lecithin and up to 0.8% tocopherol.

Fish oil itself is a known raw material and is the generic name for poor-drying oils which are obtained by extraction or pressing from the whole body of clupeids, such as anchovies, herrings, sardines or sprats, or from fish processing waste. The press residues provide the fish meal. The composition of fish oils is characterized by the high percentage of polyunsaturated fatty acids containing 4 to 6 double bonds. By contrast, the percentage of autoxidative tocopherol is relatively low. It can be of advantage to use fatty acids based on herring oil for the purposes of the invention.

The compounds of formula (I) used in accordance with the invention are nonionic compounds which may be additionally characterized by their HLB value (hydrophilic/lipophilic balance as defined by Griffin; see Römpp, Lexikon Chemie, 10th Edition 1997, page 1764). Preferred preparations contain the compounds of formula (I) with HLB values of 4 to 10 and more particularly 5 to 9.

According to the invention, the compounds of formula (I) are used as adjuvants in standard agrochemical formulations. Liquid and more particularly water-containing formulations are preferably prepared from plant protection agents and adjuvants and then used, for example as spray broths or so-called tank mixes.

The compounds of formula (I) according to the invention are present in the agrochemical preparations directly suitable for application in quantities of preferably 0.05 to 5% by weight, but more especially 0.1 to 1% by weight. In principle, however, the compounds of formula (I) may also be introduced into solid formulations. The compounds of formula (I) may also be used as a formulation ingredient of liquid concentrates.

The present invention also relates to a process for improving the resistance to rain of plant protection agents, more particularly water-based plant protection agents, characterized in that compounds of formula (I) are added to the plant protection agents in effective quantities, preferably in quantities of 0.05 to 5% by weight, based on the plant protection agent.

### EXAMPLES

Rain resistance tests were carried out with the semisystemic fungicide prochloraz and its commercial formulation Sportak EC and with the contact fungicide tolylfluanid and its commercial formulation Euparen M.

Sprayable formulations of the active substances and the compounds of formula (I) according to the invention were prepared according to the emulsifier content of the commercial formulations and were applied as directed by the manufacturer. After 2 or 24 h, the test plants were exposed for 6,5 h to 25 mm artificial rain. The residues of the formulations on the plants were then measured.

It was found that ethoxylated linseed oils in particular drastically increase rain resistance in relation to commercial products and that even ethoxylated rapeseed oils produce a significant increase in rain resistance in the case of the Sportak formulation and, in the case of Euparen M. at least lead to a formulation comparable with the commercial product.

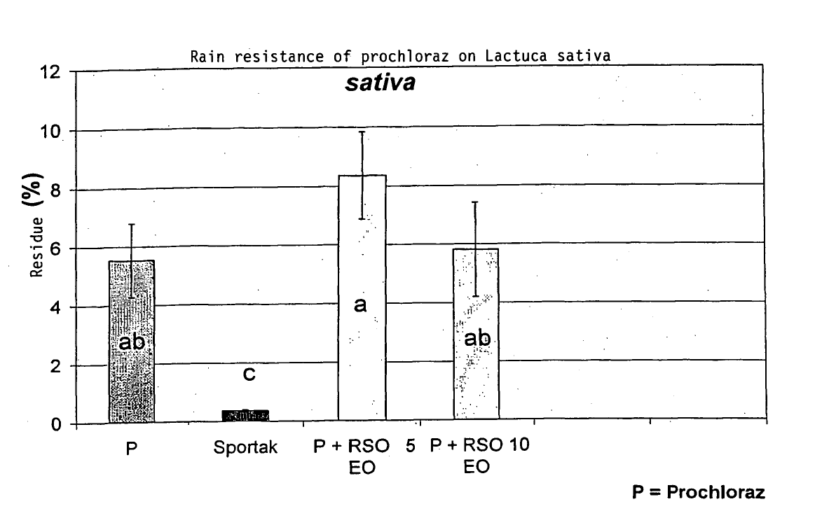

The results for prochloraz are also shown in the form of a graph in FIG. 1 where RSO stands for rapeseed oil derivative. The residue of plant protection agent on the plants was measured by GC analysis.

1. The use of compounds corresponding to general formula (I):
RO—(C₂H₄O)ₙ(C₃H₆O)ₘ—R′ (I)
in which
RO is an alcohol residue selected from the group of branched or linear, saturated or unsaturated monohydric alcohols containing 1 to 6 carbon atoms or polyols containing 2 to 12 carbon atoms and 2 to 6 hydroxyl groups,
R′ is hydrogen and/or a group —CO—R″, where R″ is a branched or linear, saturated or unsaturated alkyl group containing 5 to 29 carbon atoms,
n is a number of 1 to 50 and
m is 0 or a number of 1 to 20,
for improving the rain resistance of agrochemical formulations after their application to the surfaces of plants.

2. The use claimed in claim 1, characterized in that compounds of formula (I) in which R″ exclusively represents a branched or linear, saturated or unsaturated alkyl group containing 5 to 29 carbon atoms are used.

3. The use claimed in claim 1 or 2, characterized in that compounds of formula (I) in which RO is a glycerol residue and R″ is a branched or linear, saturated or unsaturated alkyl group containing 17 to 21 carbon atoms are used.

4. The use claimed in claims 1 to 3, characterized in that compounds of formula (I) in which n is a number of 1 to 50 and m is 0 or a number of 1 to 5 are used.

5. The use claimed in any of claims 1 to 4, characterized in that compounds of formula (I) in which n has a value of 5, 10, 30 or 50 and m is 0 are used.

6. The use claimed in claims 1 to 5, characterized in that compounds of formula (I) in which —CO—R″ is a ricinoleic acid residue and RO is a glycerol residue are used.

7. The use claimed in claim 1, characterized in that compounds of formula (I) in which RO is a methanol residue and R″ is a branched or linear, saturated or unsaturated alkyl group containing 5 to 17 carbon atoms are used.

8. The use claimed in any of claims 1 to 7, characterized in that compounds of formula (I) which have an HLB value of 4 to 10 are used.

9. The use claimed in claim 1, characterized in that ethoxylated rapeseed oil is used as the compound of formula (I).

10. The use claimed in claim 1, characterized in that ethoxylated soybean oil is used as the compound of formula (I).

11. The use claimed in claim 1, characterized in that ethoxylated linseed oil is used as the compound of formula (I).

12. The use claimed in claim 1, characterized in that ethoxylated fish oil, preferably ethoxylated herring oil, is used as the compound of formula (I).

13. The use claimed in claims 1 to 12, characterized in that, in formula (I), R′ stands for a group —CO—R″ where R″ is an unsaturated, preferably polyunsaturated, alkenyl group.

14. The use claimed in claim 13, characterized in that compounds of formula (I) obtained by reaction of fatty acids having iodine values of 100 to 170 are used.

15. The use claimed in claims 9 to 14, characterized in that rapeseed oil, soybean oil or linseed oil was reacted with 5 to 50 mol, preferably 5 to 30 and more particularly 5 to 10 mol ethylene oxide per mol oil.

16. A process for improving the resistance of plant protection agents to rain, characterized in that compounds of formula (I) in claim 1 are added to the plant protection agents.
